(19) United States
(12) Patent Application Publication
(10) Pub. No.: US 2016/0207411 A1
(43) Pub. Date: Jul. 21, 2016

(54) DEVICE FOR CHARGING AN AUTOMOTIVE VEHICLE BATTERY MAKING IT POSSIBLE TO COMPENSATE FOR THE HARMONICS, AUTOMOTIVE VEHICLE FURNISHED WITH SUCH A CHARGING DEVICE AND CORRESPONDING METHOD OF CHARGING

(71) Applicant: RENAULT S.A.S., Boulogne Billancourt (FR)

(72) Inventors: Ludovic MERIENNE, Gif sur Yvette (FR); Pedro KVIESKA, Versailles (FR)

(73) Assignee: RENAULT S.A.S., Boulogne Billancourt (FR)

(21) Appl. No.: 15/022,690

(22) PCT Filed: Sep. 12, 2014
(86) PCT No.: PCT/FR2014/052267

§ 371 Date: Mar. 17, 2016

(30) Foreign Application Priority Data
Sep. 18, 2013 (FR) 1358969

(51) Int. Cl. B60L 11/18

(52) U.S. Cl. CPC B60L 11/1838; B60L 11/1811

(57) ABSTRACT

A battery charging device for a motor vehicle battery with at least partially electric traction includes a filtering stage to be connected to an electrical power supply network, a voltage buck stage connected to the filtering stage, a voltage boost stage coupled to the voltage buck stage and to be connected to the battery, and a regulation unit to impose chopping duty cycles on the voltage buck stage and on the voltage boost stage. The regulation unit compensates the harmonics generated by the voltage buck stage in the filtering stage, acting on the voltage buck stage.

The invention relates to a device for charging a battery and, more particularly, a charging device intended to be incorporated in a motor vehicle with at least partially electric traction to allow for a recharging of the vehicle battery directly from an electrical power supply network.

In high-voltage battery recharging systems, the electrical power of the network is routed to the battery in turn through two converters: a voltage buck and a voltage boost. These two converters respectively make it possible to lower and raise the voltage ratio between their output, terminal and their input terminal, by successively opening and closing a series of switches, at a frequency which is controlled as a function of the output current, and/or of the desired output voltage.

Such recharging systems are for example described in the patent application FR 2 943 188, which relates to an embedded recharging system for a motor vehicle, making it possible to recharge a vehicle battery from a three-phase or single-phase circuit, the recharging circuit incorporating the coils of an electrical machine which also ensures other functions, like current generation or vehicle propulsion.

Reference can also be made to the document FR 2 964 510 which describes the recharging of a battery from a three-phase circuit and to the document FR 2 974 253 which describes the recharging of a battery from a single-phase power supply and which also describes an architecture making it possible to control the charging power.

The chopping of the current drawn from the power supply network generated by the operation of the voltage buck stage induces high-frequency components in the current drawn, that is to say harmonics of an order higher than the fundamental of the distribution network which is conventionally 50 Hz.

With the electricity distributors imposing a standard on the harmonics of the current drawn, such a recharging system also includes a filter of RLC (resistive-inductive-capacitive) type at the input of the voltage buck.

Such an input filter makes it possible to filter the absorbed current such that it satisfies the network connection requirements imposed by the network operators, in terms of harmonics, as well as those of the automotive field.

Such an input filter is also designed to allow for the correct power mode operation of the charger.

In reality, it is not suitable for absorbing the harmonic content returned by the charging device to the network. In other words, the returned current is not perfectly sinusoidal. The filter is in fact only suitable for absorbing the harmonic content generated at a predetermined frequency, in this case 10 kHz, by the chopping of the currents in the voltage buck stage.

The aim of the invention is thus to propose a battery charging device designed to be able to be connected to an electrical power supply network and capable of opposing the appearance of a harmonic content in the power supply network.

Therefore, the subject of the invention, according to a first aspect, is a battery charging device, notably for a motor vehicle battery with at least partially electric traction, comprising a filtering stage intended to be connected to a power supply network, a voltage buck stage connected to the filtering stage, a voltage boost stage coupled to the voltage buck stage and intended to be connected to the battery and a regulation unit suitable for imposing chopping duty cycles on the voltage buck stage and on the voltage boost stage.

The regulation unit comprises means for compensating the harmonics generated by the voltage buck stage in the filtering stage, acting on the voltage buck stage.

According to another feature of the invention, the regulation unit comprises a main regulator suitable for determining a duty cycle of a switching control signal for the voltage buck stage, and a secondary regulator for compensating harmonics suitable for determining a duty cycle of a harmonics compensating signal combined with said control signal.

The secondary regulator is for example associated with a comparator suitable for comparing the current drawn from the network and a compensated ideal current for generating the duty cycle of the compensating signal on the basis of the result of said comparison.

The compensated ideal current can be generated from a phase-locked loop.

In one embodiment, the secondary regulator comprises an elliptical filter ensuring the filtering of the result of said comparison and associated with an amplification stage with adjustable gain whose output is connected to a current divider such that the duty cycle αₕₐᵣₘ of the compensating signal is generated on the basis of the relationship:

$${α}_{harm} = \frac{{K}_{p} Δ {I}_{filtered} }{{I}_{n}}$$

in which Kp denotes the adjustable gain,

ΔI_{filtered} is the output of the elliptical filter, and Iₙ is the output current of the voltage buck stage.

Another subject of the invention, according to another aspect, is a motor vehicle with at least partially electric traction, comprising a charging device as defined above.

Yet another subject of the invention, according to a third aspect, is a battery charging method, notably for a battery of a motor vehicle with at least partially electric traction, in which the current delivered by an electrical power supply network is filtered and the electrical power of the network is routed to the battery via a voltage buck stage and a voltage boost stage while controlling the chopping duty cycle of said voltage buck and boost stages.

According to a general feature of this method, the harmonics generated by the voltage buck stage are compensated in a filtering stage for the current delivered by the network.

In one implementation, said compensation of the harmonics is implemented by combining a main regulation suitable for determining a duty cycle of a switching control signal for the voltage buck stage and a secondary regulation for compensating the harmonics, the secondary regulation being implemented on the basis of a comparison between the current delivered by the network and a compensated ideal current.

The compensated ideal current is for example generated from a measurement of the pulsing of the network current.

In one implementation, the result of said comparison is filtered by an elliptical filter, amplified by a variable gain amplifier then divided by the output current of the voltage buck stage.

Other aims, features and advantages of the invention will become apparent on reading the following description, given purely as a nonlimiting example, and with reference to the attached drawings in which:

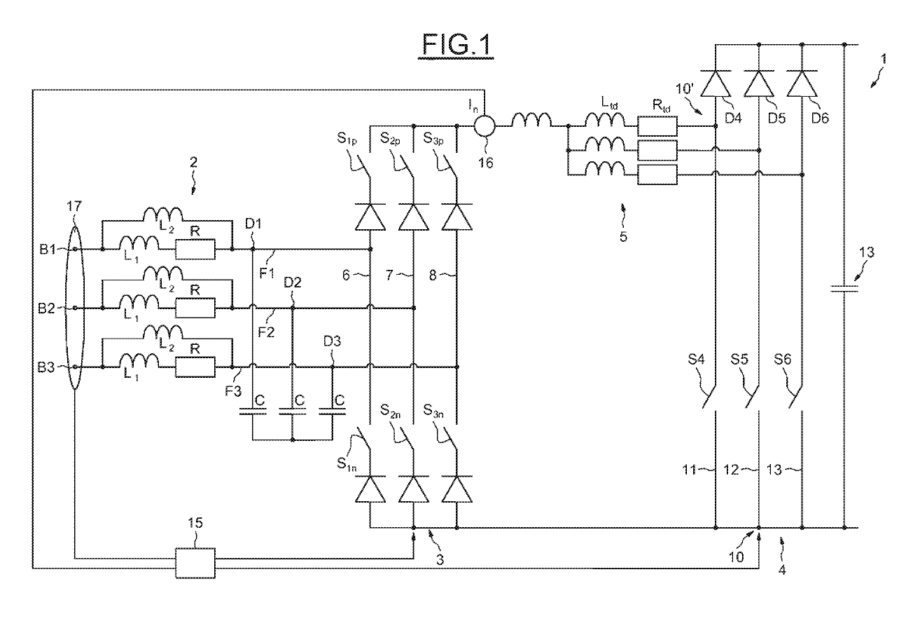

FIG. 1 illustrates a battery recharging device according to an embodiment of the invention;

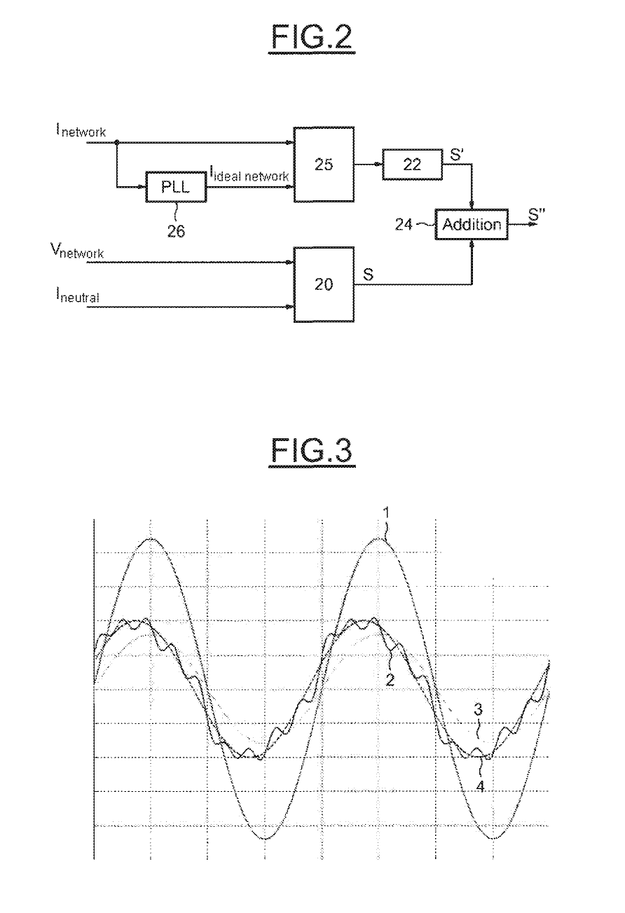

FIG. 2 is a diagram illustrating, generally, the structure of the regulation unit;

FIG. 3 shows curves illustrating the generation of the ideal current;

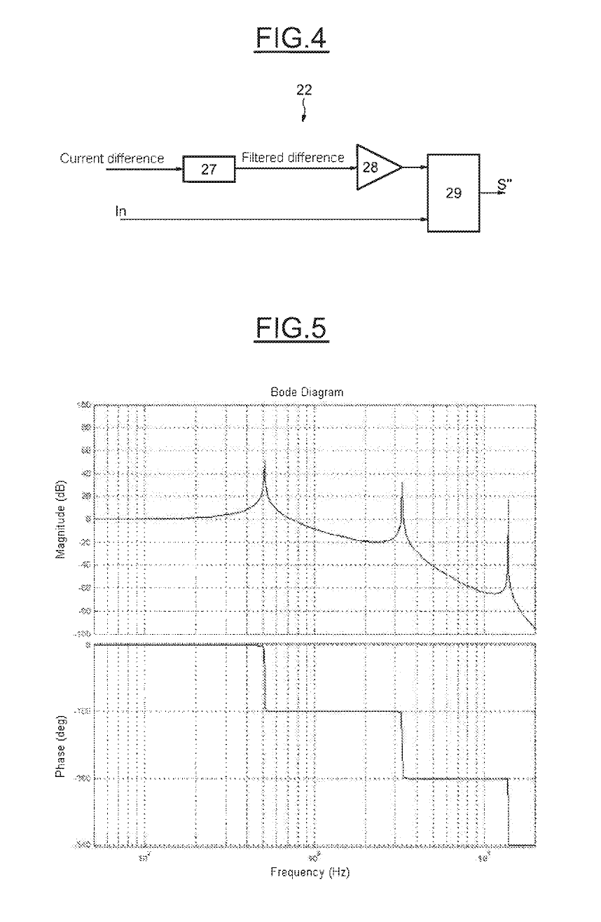

FIG. 4 is a diagram illustrating an embodiment of the regulation unit;

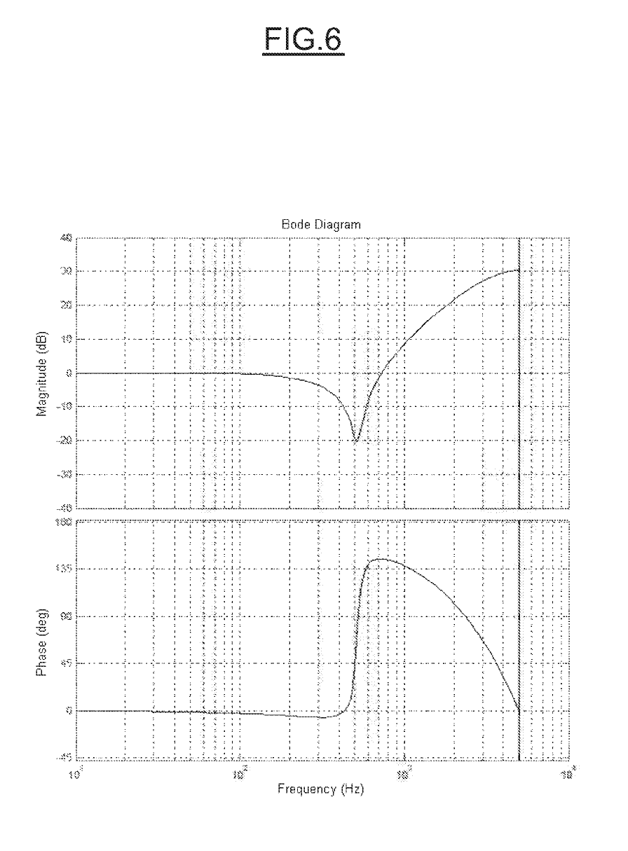

FIGS. 5 and 6 show curves illustrating the operation of the elliptical filter.

FIG. 1 shows, schematically, a device for charging a battery of a motor vehicle with electric traction from a three-phase power supply network, according to an embodiment.

The recharging device 1 comprises a filtering stage 2, a voltage buck stage 3 coupled to the filtering stage 2, and a voltage boost stage 4 coupled to the voltage buck stage 3 via an electrical machine 5.

The device 1 is here, for example, intended to be coupled to a three-phase power supply. It comprises three terminals B₁, B₂, B₃ coupled at the input of the filtering stage 2, and suitable for being coupled to a power supply network. It will however be noted that, in single-phase recharging mode, only the inputs B₁ and B₂ are coupled to a single-phase power supply network.

Each input terminal B₁, B₂ and B₃ is coupled to a filtering branch of the filtering stage 2. Each filtering branch comprises two branches in parallel, one bearing an inductor of value L₂ and the other bearing, in series, an inductor of value L₁ and a resistor of value R.

These two filtering branches are each coupled at the output to a capacitor of capacitance C for example coupled to the ground, at a point respectively named D₁, D₂, D₃ for each of the filtering branches. Together, the resistors of value R, the inductors of values L₁ or L₂, and the capacitors of capacitance C constitute a filter of RLC type at the input of the voltage buck 3.

The voltage buck stage 3 is coupled to the filtering stage 2 by the points D₁, D₇ and D₃. The voltage buck 3 comprises three parallel branches 6, 7 and 8, each bearing two switches such as S₁ₙ and S₁ₚ controlled by a regulation unit 15 and two diodes.

Each input D₁, D₂ or D₃ of the voltage buck is connected, respectively by a branch F₁, F₂ and F₃, to a connection point situated between two switches such as S₁ₙ or S₁ₚ of a same branch, respectively 6, 7 and 8.

The common ends of the branches 6, 7 and 8 constitute two output terminals of the voltage buck 3. One of the terminals is linked to the “−” terminal of the battery 13 and to a first input 10 of the voltage boost stage 4. The other of these terminals is connected to a first terminal of an electrical machine 5, the other terminal of which is connected to a second input 10′ of the voltage boost 4.

The voltage boost stage 4 here comprises three parallel branches 11, 12 and 13 each comprising a diode D₄, D₅ and D₆ associated with a switch S₄, S₅ and S₆ that can be controlled by the regulation unit 15 independently. These switches S₄, S₅ and S₆ are situated on a branch linking the first input 10 of the voltage boost 4 and the “+” terminal of the battery 13.

As can be seen, the battery 13 is connected in parallel on the three branches 11, 12 and 13 of the voltage boost stage.

The electrical machine 5 can here be likened to three parallel branches each comprising a resistor R_{td} in series with an induction coil L_{td} and connected between the diode D₄, D₅ or D₆ and the corresponding controllable switch S₄, S₅ and S₆ of the respective branches 11, 12 and 13.

It can final y be seen in FIG. 1 that the recharging device 1 is complemented by a member 16 for measuring the output current I_{N} of the voltage buck stage 3. This current I_{N}, hereinafter designated by the neutral current term by virtue of the fact that this current arrives at a star-configuration interconnection of the three stator windings of the electrical machine 5, at the output of the buck stage 3.

The recharging device is also complemented by a member 17 for measuring the current drawn from the network.

As will be described in detail hereinbelow, these measurement currents are delivered to the regulation unit 15, notably to ensure a compensation of the harmonics created in the operation of the buck stage 5 and likely to be injected into the network after having been amplified by the input filter 2.

In operation, the regulation unit 15 determines, as is known, the duty cycle of switching control signals for the switches of the voltage buck and boost stages, for example consisting of transistors. They are preferably transistors that allow for fast switching, for example transistors of IGBT (Insulation Gate Bipolar Transistor) type.

The regulation unit 15 can, for example, comprise a first control module making it possible to determine the chopping duty cycle of the voltage buck stage and a second control module making it possible to determine a chopping duty cycle setpoint for the voltage boost stage.

As is known, to assess the duty cycles, the regulation unit receives, for example as input, the values of the network power supply voltage, of the intensity of the current passing through the electrical machine, of the battery voltage 13 and of the intensity of the current passing through the battery.

With respect to the control module dedicated to the control of the voltage buck stage 3, the regulation unit 15 controls the switches of this buck stage so as to reduce, even cancel, the harmonics generated in the chopping.

FIG. 2 shows an exemplary embodiment of the first module of the regulation unit making it possible to determine the chopping duty cycle of the voltage buck stage.

As can be seen, the regulation unit comprises a main regulator 20 receiving, as input, a measurement value of the voltage V_{network} of the network and of the neutral current Iₙₑᵤₜᵣₐₗ to generate a switching control signal S for the voltage buck stage, as is known per se.

The regulation unit also comprises a secondary regulator 22 for compensating the harmonics that is intended to assess the duty cycle of a harmonics compensating signal S′ intended to be combined with the switching control signal S by means of an adder 24 to generate a final control signal S″.

As can be seen, the secondary regulator 22 ensures the comparison between the value of the current I_{network} and the value of an ideal current I_{deal network} by means of a subtractor 25.

Reference is now made to FIG. 3, in which the curve 1 represents the network voltage, the curve 2 designates the current drawn from the network, the curve 3 designates the desired current and the curve 4 designates the ideal network current.

It can be seen that, for the reasons explained previously, the current drawn from the network is not purely sinusoidal at 50 Hertz because of its harmonic content.

From this current I_{network}, a phase-locked loop PLL 26 is used which makes it possible to extract the pulsing wt of the network current, measured by the measurement member 17 to generate the current I_{ideal network} (curve 4).

Thus, from the result of the subtraction implemented by the subtractor 25, the secondary regulator is capable of generating the compensating signal S″ making it possible to add a curative component to the control signal S obtained from the main regulator 20 and in this way reduce the harmonic content of the network.

It will be noted that, for this, the regulation unit advantageously takes account of the passage through the filtering stage 2.

To this end, and as can be seen in FIG. 4, the secondary regulator 22 includes an input elliptical filter 27 receiving, as input, the result of the comparison delivered by the subtractor 25 and a variable gain amplifier stage 28 receiving as input the filtered comparison result and whose output is connected to a divider 29 ensuring the division between the output of the variable gain amplification stage 28 and the neutral current measurement value supplied by the measurement member 16 to provide the harmonic compensating signal S″.

In other words, the duty cycle u αₕₐᵣₘ of the harmonic compensating signal S″ is generated from the following relationship:

$${α}_{harm} = \frac{{K}_{p} Δ {I}_{filtered} }{{I}_{n}}$$

which:

Kp denotes the adjustable gain of the amplification stage 28;

ΔI_{filtered} is the output of the elliptical filter 27; and

Iₙ is the output current of the voltage buck stage.

The advantage from the use of the elliptical filter will become apparent on studying FIGS. 5 and 6.

FIG. 5 shows the Bode diagram translating the modification of the current between the filtering stage 2 and the buck stage 3 due to the modification of the control of the voltage buck stage to compensate the harmonics.

A phase inversion is observed around 500 Hertz, which means that a simple proportional corrector is not optimal to implement the secondary regulator 22.

In effect, such a corrector could indeed compensate the harmonics below 500 Hertz but, above, would make them worse.

To be able to act on all the harmonics of the network, the elliptical filter 27 is used that makes it possible to avoid the phase inversion beyond 500 Hertz. FIG. 6 shows said Bode diagram of such a filter.

1-10.(canceled)

11. A battery charging device for a motor vehicle battery with at least partially electric traction, comprising:
a filtering stage to be connected to an electrical power supply network;
a voltage buck stage connected to the filtering stage;
a voltage boost stage coupled to the voltage buck stage and to be connected to the battery; and
a regulation unit to impose chopping duty cycles on the voltage buck stage and on the voltage boost stage, the regulation unit including means for compensating the harmonics generated by the voltage buck stage in the filtering stage, acting on the voltage buck stage.

12. The charging device as claimed in claim 11, in which the regulation unit comprises a main regulator to determine a duty cycle of a switching control signal for the voltage buck stage and a secondary regulator to compensate harmonics to determine a duty cycle of a harmonics compensating signal combined with said control signal.

13. The charging device as claimed in claim 12, in which the secondary regulator is associated with a comparator to compare the current drawn from the network and a compensated ideal current for generating the duty cycle of the compensating signal based on a result of said comparison.

14. The charging device as claimed in claim 13, in which the compensated ideal current is generated from a phase-locked loop.

15. The charging device as claimed in claim 14, in which the secondary regulator comprises an elliptical filter ensuring the filtering of the result of said comparison associated with an amplification stage with adjustable gain whose output is connected to a current divider such that the duty cycle of the compensating signal is generated based on the relationship:
$${α}_{harm} = \frac{{K}_{p} Δ {I}_{filtered} }{{I}_{n}}$$
in which:
Kp denotes the adjustable gain;
ΔI_{filtered} is the output of the elliptical filter; and
Iₙ is the output current of the voltage buck stage.

16. A motor vehicle with at least partially electric traction, comprising:
a charging device as claimed in claim 11.

17. A battery charging method for a battery of a motor vehicle with at least partially electric traction, comprising:
filtering current delivered by an electrical power supply network;
routing electrical power of the network to the battery via a voltage buck stage and a voltage boost stage while controlling the chopping duty cycles of said voltage buck and boost stages; and
compensating harmonics generated by the voltage buck stage in a filtering stage for the current delivered by the network.

18. The method as claimed in claim 17, in which said compensating the harmonics is implemented by combining a main regulation to determine a duty cycle of a switching control signal for the voltage buck stage and a secondary regulation to compensate the harmonics, the secondary regulation being implemented based on a comparison between the current delivered by the network and a compensated ideal current.

19. The method as claimed in claim 18, in which the compensated ideal current is generated from a measurement of pulsing of the network current.

20. The method as claimed in claim 19, in which a result of said comparison is filtered by an elliptical filter amplified by a variable gain amplifier then divided by the output current of the voltage buck stage.
